(19) United States
(12) Patent Application Publication
(10) Pub. No.: US 2007/0018910 A1
(43) Pub. Date: Jan. 25, 2007

(54) Method and apparatus for initiating gas discharge displays

(75) Inventor: Charles K. Hanneman, Olathe, KS (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/189,586

(22) Filed: Jul. 25, 2005

(51) Int. Cl. G09G 3/10

(52) U.S. Cl. 345/37

(57) ABSTRACT

A method and apparatus are provided for initializing ionization of a gas discharge display. The gas discharge display includes a keep-alive area electronically coupled to circuitry including one or more light emitting diode (LED). The keep-alive chamber is also optically coupled to the LED. The circuitry measures current through the keep-alive area and the method includes the step of activating the LED in response to the current through the keep-alive area falling below a predetermined threshold current.

### FIELD OF THE INVENTION

The present invention generally relates to gas discharge displays, and more particularly relates to an improved method and apparatus for starting the ionization process in a gas discharge display.

### BACKGROUND OF THE INVENTION

Many instrument displays in high ambient light areas, such as those instrument displays in aircraft cockpits, utilize gas discharge displays. Conventional gas discharge displays use a radioactive gas, such as Krypton 85, in the gas mixture of the gas discharge displays to provide initial ions to quicken the starting of these gas discharge displays. The presence of a radioactive isotope, however, increases the shipping costs of the gas discharge displays and the products that use them. In addition, each time these gas discharge displays or products which use them are shipped from country to country, an import license is required to import the radioactive material, thereby further increasing the cost of the gas discharge displays.

Thus, it is desirable to provide gas discharge displays which do not contain radioactive isotopes, yet retain the quick start time of conventional gas discharge displays. What is needed, therefore, is an improved method and apparatus for initiating the ionization process in gas discharge displays. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for maintaining ionization of a gas discharge display. The gas discharge display includes a keep-alive area within a gas discharge chamber of the display. The keep-alive area is electronically coupled to circuitry including an energy source, such as one or more light emitting diodes (LEDs). The keep-alive area is also coupled to the energy source in another manner, such as optically. The circuitry measures current through the keep-alive area and the method includes the step of activating the energy source in response to the current through the keep-alive area being below a predetermined threshold current.

### BRIEF DESCRIPTION OF THE DRAWINGS

The present invention will hereinafter be described in conjunction with the following drawing figures, wherein like numerals denote like elements, and

FIG. 1 is a depiction of a cockpit display which utilizes gas discharge for display of numerical information and nomenclature;

FIG. 2 is a block diagram of the gas discharge display of FIG. 1 in accordance with the preferred embodiment of the present invention; and

FIG. 3 is a circuit diagram of the starting circuit for the gas discharge display of FIG. 2 in accordance with the preferred embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

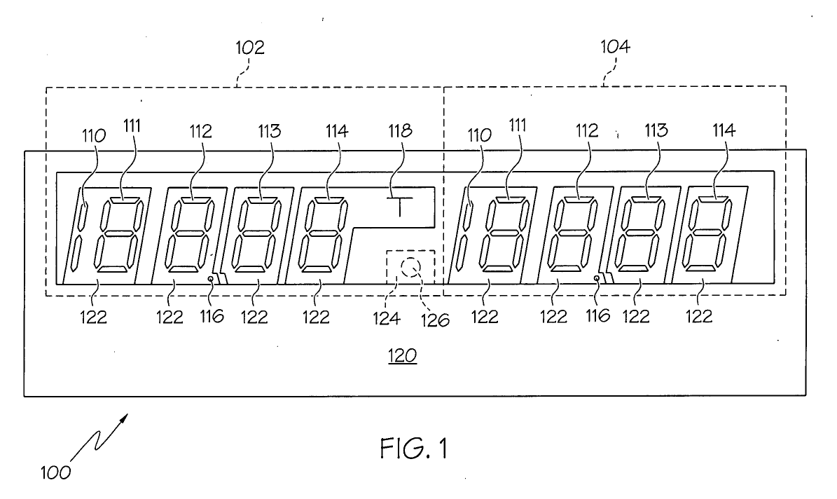

Referring to FIG. 1, a cockpit gas discharge display 100 displays radio frequency information. The radio frequency information is presented on one of two portions 102, 104 of the display 100, each portion 102, 104 including up to five digits 110, 111, 112, 113, 114, with a decimal point 116 between the third and fourth digits 112, 113. The first digit 110 of each portion 102, 104 may be a “1”. The other digits 111, 112, 113, 114 are displayed by activating in a manner well known to those skilled in the art the appropriate segments of each digit to form a numeral from “0” to “9”. The first portion 102 may indicate a transmitting radio frequency if the “T” 118 is lit.

A faceplate 120 is metallized glass and, for proper readout of the digital information, the metallization is etched off display areas 122 of the glass around the digits 110, 111, 112, 113, 114 and the transmission frequency indicator 118. Dielectric material effectively masks the other areas of the gas discharge display 100 from the user, including a keep-alive area 124 and an energy source 126 coupled to the keep-alive area 124 to provide energy thereto, such as a light emitting diode (LED) 126 optically coupled to the keep-alive area 124.

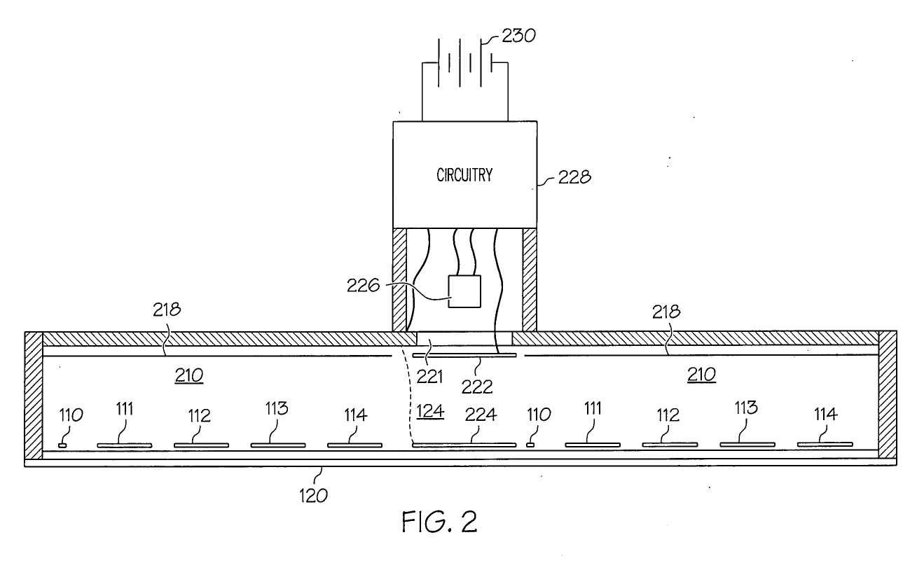

Referring to FIG. 2, a gas discharge chamber 210 is located behind the faceplate 120 for containing ionizable gas for display of the segments of the digits 110, 111, 112, 113, 114 in response to activation of those segments. The segments of the digits 110, 111, 112, 113, 114 are cathodes formed onto the faceplate in the display areas 122 (FIG. 1) by conventional thick film processing. First a dielectric is screened and fired onto the glass of the display areas 122 for insulation, then interconnects for connecting the segments to display circuitry (not shown), then another layer of dielectric for insulation, and finally metallization for the segments 110, 111, 112, 113, 114.

The gas discharge chamber 210 also has the keep-alive area 124 integral to the gas discharge chamber 210 to keep a small segment of the gas ionized for quick starting of the gas discharge in other areas of the chamber when it is activated. The keep-alive area 124 is bounded by an anode 222 and a cathode 224 for ionization of gas therebetween. The light emitting diode (LED) 126 shines through a transparent material 221 into the keep-alive area 124 for optically coupling therewith. The LED 126 may be any energy source and may be one or more than one LED and may be a white LED, an infrared LED, an ultraviolet LED or any other LED, so long as the energy emitted by the LED (or LEDs) is sufficient, after passing through material 221 to ionize the gas in the keep-alive area 124.

A power source 230 is coupled to the circuitry 228 for providing sufficient voltage to flow a current through the gas of the keep-alive area 124 and the anode 222 and cathode 224 of the keep-alive area 124 are also electronically coupled to the LED 126 through circuitry 228 to sense the current passing through the gas therebetween. The light from the LED 126 and the ionized gas in the keep-alive area 124 are masked at the display 100 by the faceplate 120 (FIG. 1) to keep the majority of the keep-alive area's 124 ionization glow and the LED 126 light from being seen by the pilot.

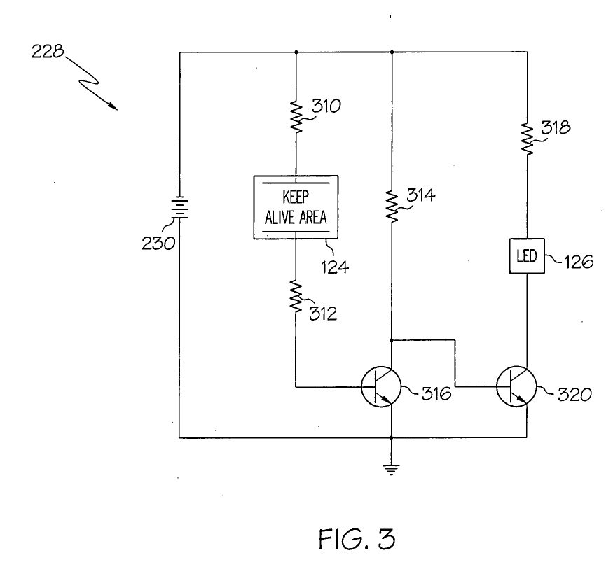

Referring to FIG. 3, in accordance with the preferred embodiment of the present invention, the power source 230 provides at least 185 volts for operation of the circuitry 228. The circuitry comprises two resistors 310, 312 coupled to the anode 222 and cathode 224 of the keep-alive area 124. The resistor 312 is also coupled to the base of a transistor 316. A resistor 314 is coupled to the collector of the transistor 316, while the emitter is coupled to ground. The collector of the transistor 316 is also coupled to the base of a transistor 320. The collector of the transistor 320 is coupled in series to the LED 126 and a resistor 318, while the emitter is coupled to ground.

In operation, the circuitry 228 operates to activate and de-activate the LED 126 in response to the ionization of the gas in the keep-alive area 124. The two transistors 316, 320 operate as a control means for activating the LED 126 in response to the ionization of the gas in the keep-alive area 124 falling below an ionization level such that the current through the keep-alive chamber falls below a predetermined level. The predetermined level, or predetermined threshold current is defined by the gain of transistor 316 and resistor 314 and the current passing through the ionized gas at which the LED 126 are to be activated.

The keep-alive area 124 current drives the base of the transistor 316. When the current is very low (i.e., prior to ionization), the transistor 316 is “off” which turns the transistor 320 “on”, thereby activating the LED 126. The LED 126, which is optically coupled to the keep-alive area 124, excites the gas in the keep-alive area 124 which causes the gas to ionize and the keep alive area 124 to start. The current through the ionized gas turns the transistor 316 “on”. This turns the transistor 320 “off”, thereby turning the LED 126 “off”.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A gas discharge display for presenting information to a user, the gas discharge display comprising:
a gas discharge chamber for providing an area to display the information, the gas discharge chamber having gas therein;
a keep-alive area within the gas discharge chamber for maintaining a small portion of the gas ionized;
an energy source electronically and non-electronically coupled to the keep-alive chamber for providing energy to the small portion of the gas for ionization thereof; and
circuitry electronically coupled to the energy source and the keep-alive chamber for activating the energy source in response to the ionization of the gas in the keep-alive chamber.

2. The gas discharge display of claim 1 wherein the circuitry comprises a control means coupled to the at least one LED and the keep-alive chamber for activating the energy source in response to current in the keep-alive chamber falling below a predetermined threshold current.

3. The gas discharge display of claim 2 wherein the circuitry comprises a resistance means coupled to the control means and the keep-alive chamber for defining the predetermined threshold current.

4. The gas discharge display of claim 1 further comprising a power source coupled to the circuitry and the keep-alive chamber for providing voltage and current to the keep-alive chamber sufficient for ionization of the gas therein.

5. The gas discharge display of claim 1 wherein the energy source comprises at least one light emitting diode (LED), the at least one LED optically coupled and electronically coupled to the keep-alive chamber.

6. The gas discharge display of claim 5 wherein the at least one LED is at least one white LED.

7. The gas discharge display of claim 5 wherein the at least one LED is at least one infrared LED.

8. The gas discharge display of claim 5 wherein the at least one LED is two LEDs.

9. A method for maintaining ionization of a gas discharge display including a keep-alive area within a gas discharge chamber, the keep-alive area electronically coupled to circuitry comprising an energy source, the keep-alive area optically coupled to the energy source and the circuitry measuring current through the keep-alive area, the method comprising the step of activating the at least one energy source in response to the current through the keep-alive area falling below a predetermined threshold current.

10. The method of claim 8 wherein the at least one energy source comprises at least one light emitting diode (LED) and wherein the step of activating comprises the step of activating the at least one LED in response to the current through the keep-alive area falling below the predetermined threshold current.
